(19) United States
(12) Patent Application Publication
(10) Pub. No.: US 2011/0289194 A1
(43) Pub. Date: Nov. 24, 2011

(54) CLOUD DATA STORAGE SYSTEM

(76) Inventor: Hsiang-Yu LEE, New Taipei City (TW)

(21) Appl. No.: 13/110,703

(22) Filed: May 18, 2011

(30) Foreign Application Priority Data
May 21, 2010 (TW) 099116333

(51) Int. Cl. G06F 15/16

(52) U.S. Cl. 709/219

(57) ABSTRACT

A cloud data storage system includes a plurality of storing units, a plurality of processing units, and a plurality of user ends. The processing units are connected to the storing units via the Internet, and the user ends are connected to one of the processing units. An upload file to be stored by a user end is divided into a plurality of file blocks, and an algorithm is used to compute eigenvalues corresponding to the file blocks respectively. The eigenvalues is computed by applying another algorithm in order to decide which storing units the file blocks can be stored in. Each of the eigenvalues corresponds to a different storing unit. For a data uploading and downloading process, the eigenvalues are used to decide the final storage locations and the information associated with combining the transferred file.

### CROSS REFERENCE TO RELATED APPLICATION

This application claims the benefits of the Taiwan Patent Application Serial Number 099116333, filed on May 21, 2010, the subject matter of which is incorporated herein by reference.

### BACKGROUND OF THE INVENTION

1. Field of the Invention

The present invention relates to a data storage system and, more particularly, to a cloud data storage system suitable for cloud computing.

2. Description of Related Art

Cloud computing is an Internet-based computing approach to provide real-time services to users via the Internet. In the near future, all users can execute programs and software and store the file data in the Internet. Thus, the transmission efficiency of the file data, the recognition and storage of repeated data, the identification and elimination of viruses, and the privacy and protection of data will be important issues of the cloud computing.

Interactions via the Internet are getting more and more with the increasing of online populations, same data and same operations (including viruses) replicated and flowed in the Internet will slow down the speed and capabilities to cause severe damages to the Internet.

For example, popular video data via transfer tools such as email, network drive, and the like can be replicated to hundreds or thousands of copies, and hundred millions times data transfer. In addition, certain popular keywords might be searched or used by hundreds or thousands of people. If such repeated actions occurred continuously, Internet resources will be wasted and the whole network can be crashed easily.

Therefore, it is desirable to provide an improved cloud data storage system to mitigate and/or obviate the aforementioned problems.

### SUMMARY OF THE INVENTION

The object of the present invention is to provide a cloud data storage system, which can reduce the repeated data storage and the repeated transfer between networks thereby to develop the actual benefits of network.

To achieve the object, the invention provides a cloud data storage system. The system includes a plurality of storing units, a plurality of processing units connected to the plurality of storing units via the Internet and a plurality of user ends connected to one of the plurality of processing units. In between, where an upload file to be stored by any user end is divided into a plurality of file blocks, the plurality of file blocks are computed by an algorithm to obtain corresponding eigenvalues. The eigenvalues are computed by another algorithm to decide which storage units the plurality of file blocks can be stored in. The plurality of eigenvalues compose a set of eigenvalues corresponds to the data file.

A first upload method in the invention is to query a storing unit by a user end whether there are same eigenvalues. The file blocks having the same eigenvalues as the corresponding storing unit are not transferred. Other file blocks not having the same eigenvalues as the corresponding storing unit are transferred to the storing unit.

In addition, each processing unit contains an eigenvalue table and a buffer area. The eigenvalue table is used to be compared with an upload file, and the buffer area is used to store the plurality of file blocks for data cache purpose.

A second upload method in the invention includes the following steps: the user end sends the eigenvalue set to one of the plurality of processing unit, and uses the eigenvalue table of the processing unit to proceed with data comparison. If the eigenvalue table contains same eigenvalues, the user end does not send the corresponding file blocks. If the eigenvalue table did not contain same eigenvalues, the processing unit sends the eigenvalues to a corresponding storing unit for data comparison. The storing unit sends back the eigenvalues not containing same eigenvalues to the processing unit. The processing unit thus makes the user end to send the corresponding file blocks not containing same eigenvalues to the buffer area of the processing unit. The processing unit sends the files blocks not containing same eigenvalues storing in the buffer area to the corresponding storing units.

A first download method in the invention includes the following steps: when one of the user ends downloads the file, according to the content of the plurality of eigenvalues set, the position of the corresponding storing unit is computed to download the corresponding file blocks. The user end combines the file blocks according to sequence of the eigenvalue set of the file.

A second download method in the invention includes the following steps: when one of the user ends downloads the file, the user end sends the eigenvalue set to one of the processing units of the plurality of the processing units and proceeds with data comparison according to the eigenvalue table of the processing unit. If the eigenvalue table of the processing unit contains the same eigenvalues, the processing unit extracts the corresponding file blocks from the buffer area to send back to the user end. If the eigenvalue table of the processing unit does not contain the same eigenvalues, the processing unit computes to get the position of the corresponding processing unit according to the eigenvalue and sends the eigenvalue to the corresponding storing unit. The storing unit sends the corresponding file block to the processing unit. The processing unit receives the corresponding file block and stores in the buffer area and sends the file block to the corresponding user end. The user end combines the file blocks according to sequence of the eigenvalue set of the file.

Other objects, advantages, and features of the invention will become more apparent from the following detailed description in conjunction with the accompanying drawings.

### BRIEF DESCRIPTION OF THE DRAWINGS

FIG. 1 is a system configuration according to an embodiment of the invention;

FIG. 2 is a first schematic diagram illustrating a file upload process according to an embodiment of the invention;

FIG. 3 is a second schematic diagram illustrating the file upload process according to an embodiment of the invention;

FIG. 4(a) is a third schematic diagram illustrating the file upload process according to an embodiment of the invention;

FIG. 4(b) is a schematic diagram of an eigenvalue table of a processing unit according to an embodiment of the invention;

FIG. 5 is a fourth schematic diagram illustrating the file upload process according to an embodiment of the invention;

FIG. 6 is a first schematic diagram illustrating a file download process of a file according to an embodiment of the invention; and

FIG. 7 is a second schematic diagram illustrating the file download process according to an embodiment of the invention.

### DETAILED DESCRIPTION OF THE PREFERRED EMBODIMENT

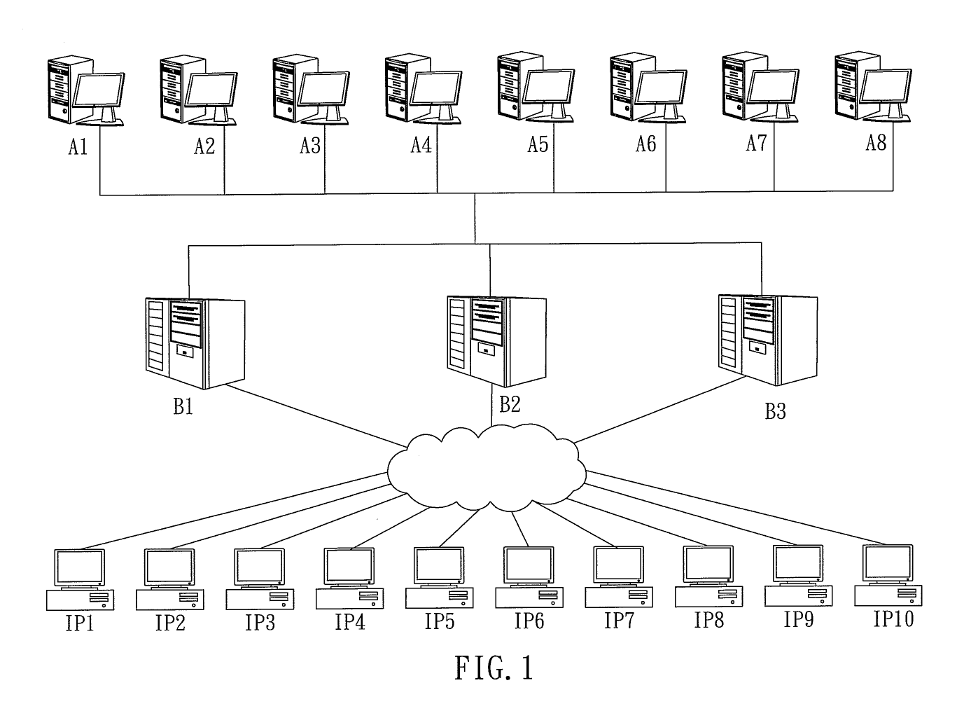

FIG. 1 is a configuration of a cloud data storage system according to an embodiment of the invention. As shown in FIG. 1, the system includes a plurality of user ends, a plurality of processing units, and a plurality of storing units. For convenience of description, in this embodiment, the system includes eight user ends A1-A8, three processing units B1-B3, and ten storing units IP1-IP10. The user ends A1-A8 are connected to at least one of the processing units B1-B3 via the Internet or a local area network (LAN), and the storing units IP1-IP10 are connected to the processing units B1-B3 via the Internet or the LAN. Each of the processing units B1-B3 includes a buffer area (not shown) to store the block data for cache purpose. Each of the user ends A1-A8 and the storing units IP1-IP10 includes a hard drive (not shown) to store the permanent data.

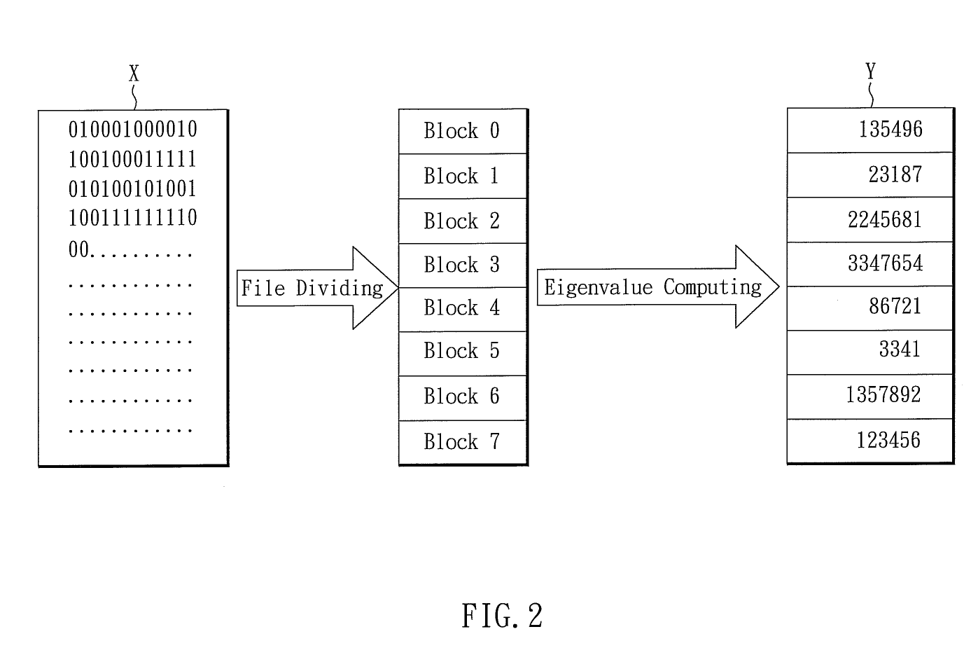

FIG. 2 is a first schematic diagram illustrating a file upload process according to an embodiment of the invention. As shown in FIG. 2, a user uses the user end A1 to upload a file X. The file X is first divided into eight blocks, Block0-Block7, for example. The file data of the eight blocks is applied to a hash algorithm, such as an MD5 algorithm, to compute the eigenvalues respectively. In this embodiment, after the computation, an eigenvalue of 135496 is obtained for Block0, 23187 for Block1, 245681 for Block2, 3347654 for Block3, 86721 for Block4, 3341 for Block5, 1357892 for Block6, 123456 for Block7. The eigenvalues form an eigenvalue set recorded in the internal eigenvalue table Y of the user end A1, and the user end A1 transfers the eigenvalue set to the processing unit B1.

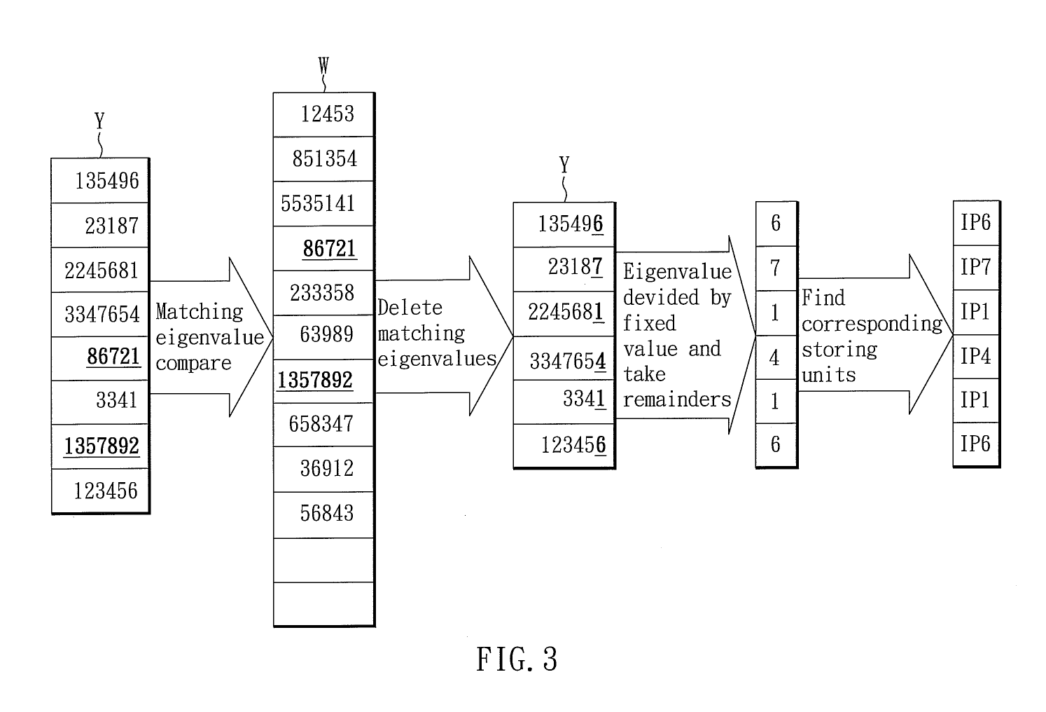

Next, FIG. 3 is a second schematic diagram illustrating the file upload process according to an embodiment of the invention. As shown in FIG. 3, when received the eigenvalue set, the processing unit B1 compares the eigenvalue set with the internal eigenvalue table W and deletes the same eigenvalues (in this case, 86721 and 1357892). The remaining eigenvalues (135496, 23187, 2245681, 3347654, 3341, 123456) are applied to another hash algorithm to obtain a set of digits corresponding to a storing unit. For example, the hash algorithm applied here makes the eigenvalues 135496, 23187, 2245681, 3347654, 3341, 123456 to be divided respectively by a fixed value (here 10 as divisor for example), and takes the remainders to form a number sequence [6, 7, 1, 4, 1, 6] corresponding to the storing units IP6, IP7, IP1, IP4, IP1, IP6 respectively. In between, the storing unit IP1 corresponds to the eigenvalues 2245681 and 3341, the storing unit IP4 corresponds to the eigenvalue 3347654, the storing unit IP6 corresponds to the eigenvalues 135496 and 123456, and the storing unit IP7 corresponds to the eigenvalue 23187.

According to the corresponding relation, the processing unit B1 transfers the eigenvalues 2245681, 3341 to the storing unit IP1, transfers the eigenvalue 3347654 to the storing unit IP4, transfers the eigenvalues 135496, 123456 to the storing unit IP6, and transfers the eigenvalue 23187 to the storing unit IP7.

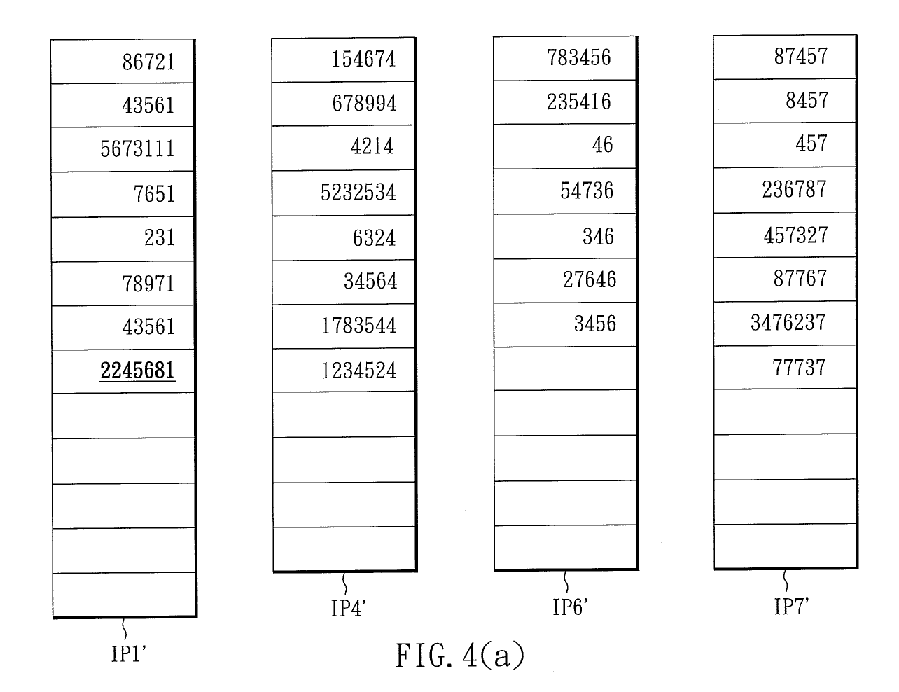

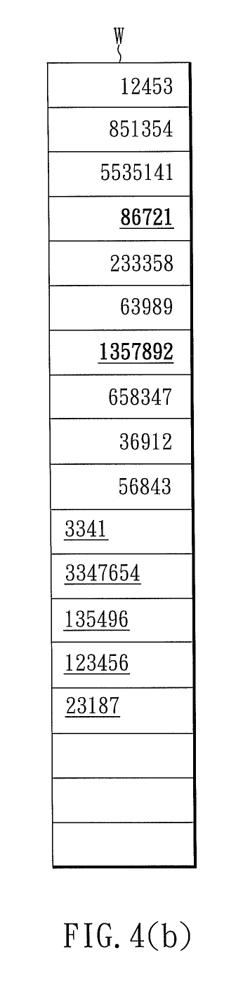

Next, FIG. 4(a) is a third schematic diagram illustrating the file upload process according to an embodiment of the invention. As shown in FIG. 4(a), after received the eigenvalues 2245681, 3341 from the processing unit B1, the storing unit IP1 compares the eigenvalues 2245681, 3341 with its own eigenvalue table IP1′ and finds to contain the eigenvalue 2245681 and not to contain the eigenvalue 3341. Therefore, the storing unit IP1 sends the eigenvalue 3341 back to the processing unit B1.

After received the eigenvalue 3347654 from the processing unit B1, the storing unit IP4 compares the eigenvalue 3347654 with its own eigenvalue table IP4′ and finds not to contain the eigenvalue 3347654. Therefore, the storing unit IP4 sends 3347654 back to the processing unit B1.

After received the eigenvalues 135496, 123456 from the processing unit B1, the storing unit IP6 compares the eigenvalues 135496, 123456 with its own eigenvalue table IP6′ and finds not to contain the eigenvalues 135496, 123456. Therefore, the storing unit IP6 sends 135496, 123456 back to the processing unit B1.

After received the eigenvalue 23187 from the processing unit B1, the storing unit IP7 compares the eigenvalue 23187 with its own eigenvalue table IP7′ and finds not to contain the eigenvalue 23187. Therefore, the storing unit IP7 sends 23187 back to the processing unit B1

After received the eigenvalues 3341, 3347654, 135496, 123456, 23187 from storing units IP1, IP4, IP6, IP7, the processing unit B1 sends those eigenvalues to the user end A1.

After received the eigenvalues 3341, 3347654, 135496, 123456, 23187 returned from the processing unit B1, the user end A1 transfers the corresponding file blocks Block5, Block3, Block0, Block7, Block1 to the processing unit B1. After received the file blocks Block5, Block3, Block0, Block7, Block1 transferred by the user end A1, the processing unit B1 stores the received file blocks in the buffer area and adds the eigenvalues 3341, 3347654, 135496, 123456, 23187 to the eigenvalue table W, as shown in FIG. 4(b).

Next, the processing unit B1 transfers the eigenvalue 3341 and the file block Block5 to the storing unit IP1, transfers the eigenvalue 3347654 and the file block Block3 to the storing unit IP4, transfers the eigenvalue 135496 and the file block Block0, the eigenvalue 123456 and the file block Block7 to the storing unit IP6, and transfers the eigenvalue 23187 and the file block Block1 to the storing unit IP7.

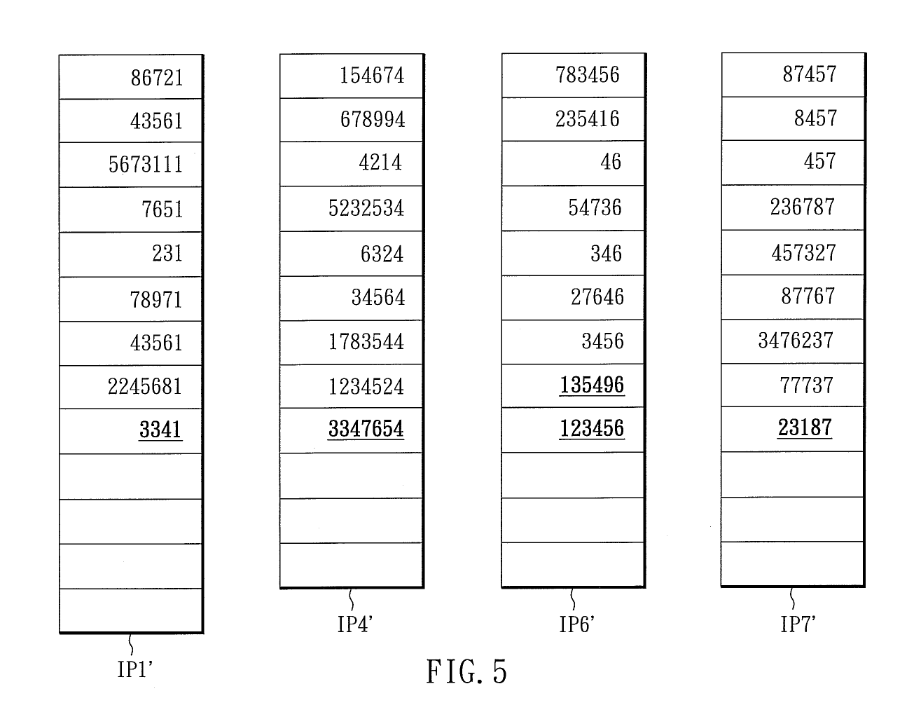

FIG. 5 is a fourth schematic diagram illustrating the file upload process according to an embodiment of the invention. As shown in FIG. 5, after received the eigenvalue 3341 and the file block Block5 transferred by the processing unit B1, the storing unit IP1 stores the file block Block5 in the internal hard drive and adds the eigenvalue 3341 to the internal eigenvalue table IP1′. After received the eigenvalue 3347654 and the file block Block3 transferred by the processing unit B1, the storing unit IP4 stores the file block Block3 in the internal hard drive and adds the eigenvalue 3347654 to the internal eigenvalue table IP4′. After received the eigenvalue 135496, the file block Block0 and the eigenvalue 123456, the file block Block7 transferred by the processing unit B1, the storing unit IP6 stores the file blocks Block0, Block7 in the internal hard drive and adds the eigenvalues 135496, 123456 to the internal eigenvalue table IP6′. After received the eigenvalue 23187 and the file block Block1 transferred by the processing unit B1, the storing unit IP7 stores the file block Blockl in the internal hard drive and adds the eigenvalue 23187 to the internal eigenvalue table IP7′.

After the user end A1 completes the upload process, the eigenvalue set (135496, 23187, 2245681, 3347654, 86721, 3341, 1357892, 123456) corresponding to the file blocks Block0-Block7 is stored in the hard drive of the user end A1 to thereby complete the data writing process and keep the eigenvalue set as a key of reading the file X in next time. The key is held and replicated by a user, so that the processing units and the storing units cannot reproduce the file X since they do not keep the eigenvalue set. Therefore, the user's data is absolutely safe without possibility of leakage.

In addition, when the user end A1 sends the eigenvalue set to the processing unit B1 and finds that the buffer area of the processing unit B1 already contained the corresponding eigenvalue set of the file X, the processing unit B1 will not proceed with the query action to IP1-IP10 and reply directly to the user end A1 with containing the corresponding file block data.

The invention also provides two cloud data download processes as follows.

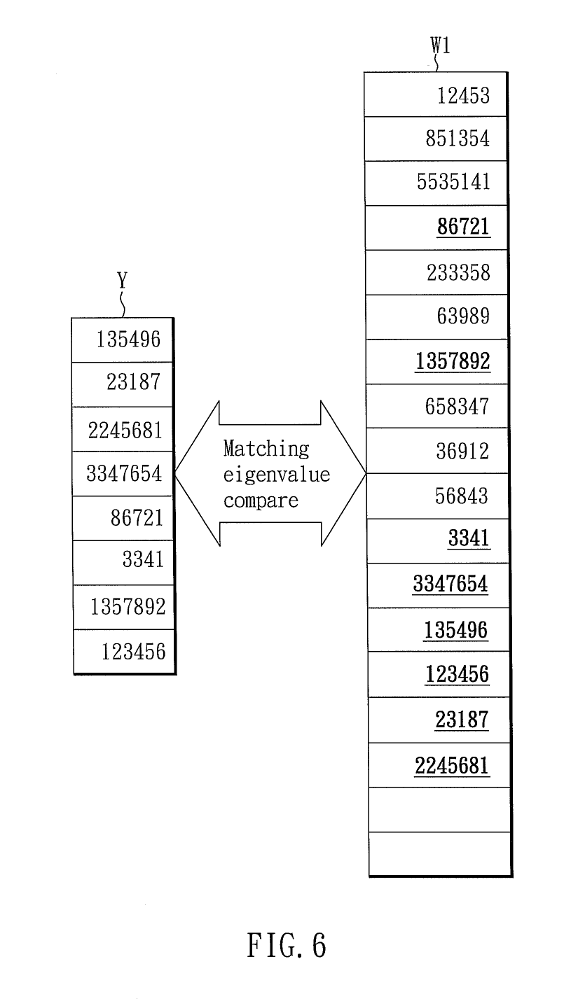

FIG. 6 is a first schematic diagram illustrating a file download process according to an embodiment of the invention. As shown in FIG. 6, the processing unit B1 has an eigenvalue table W1 with the eigenvalues of the user end A1.

First, the user end A1 extracts the eigenvalue set Y of the file X from the internal hard drive and transfers the eigenvalue set (135496, 23187, 2245681, 3347654, 86721, 3341, 1357892, 123456) to the processing unit B1. After received the eigenvalue set, the processing unit B1 compares with the eigenvalue table W1. From FIG. 6, it is known that all eigenvalues are successfully compared as matched, so the processing unit B1 reads the file blocks Block0-Block7 corresponding to the eigenvalues from the internal buffer area and returns the file blocks to the user end A1. After received the file blocks Block0-Block7 transferred by the processing unit B1, the user end A1 recombines the file blocks Block0-Block7 into the complete file X based on the sequence of the eigenvalue set to thereby complete the data download process. In this case, the data fully comes from the processing unit B1, and thus there is no need to read from far-end storing units, so as to increase the efficiency of Internet or Web utility and reduce the waste of resource.

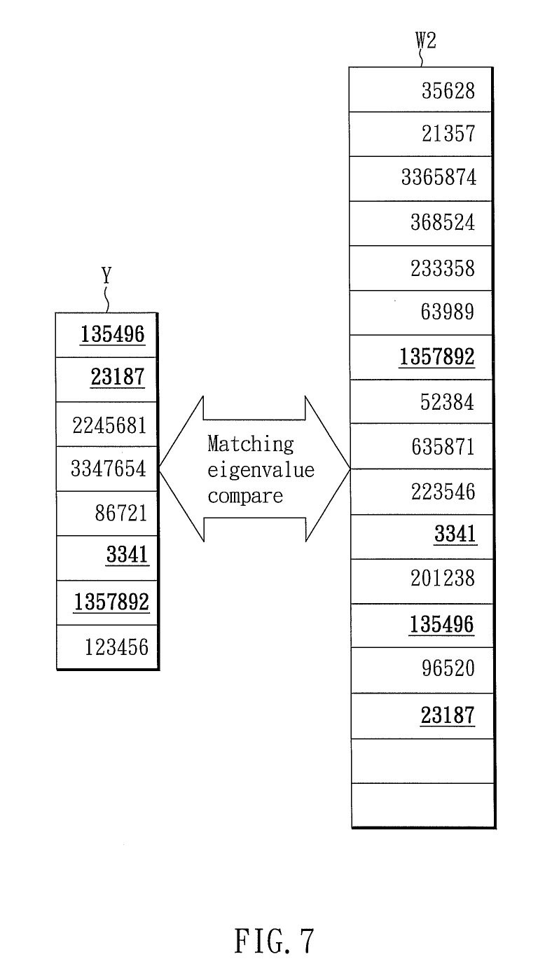

FIG. 7 is a second schematic diagram illustrating the file download process of FIG. 7 according to an embodiment of the invention. As shown in FIG. 7, the eigenvalue table W2 of the processing unit B2 does not contain all eigenvalues of the eigenvalue table Y of the user end A1.

First, the user end A1 extracts the eigenvalue set Y of the file X from the internal hard drive and transfers the eigenvalue set (135496, 23187, 2245681, 3347654, 86721, 3341, 1357892, 123456) to the processing unit B2. After received the eigenvalue set, the processing unit B2 compares the eigenvalue set Y with the eigenvalue table W2. It is seen in FIG. 7 that only part of the eigenvalues is successfully compared as matched. In this case, the processing unit B2 reads the file blocks (Block6, Block5, Block0, Block1) corresponding to the successfully matched eigenvalues (1357892, 3341, 135496, 23187) from the internal buffer area and sends them back to the user end A1. According to the hash algorithm used in the upload process, the mismatched eigenvalues (2245681, 3347654, 86721, 123456) are divided by a fixed value 10 so as to obtain a number sequence [1, 4, 1, 6] and find the storing units IP1, IP4, IP1, IP6 corresponding to the number sequence. In between, the storing unit IP1 corresponds to the eigenvalues 2245681, 86721, the storing unit IP4 corresponds to the eigenvalue 3347654, and the storing unit IP6 corresponds to the eigenvalue 123456. Then the processing unit B2 transfers the eigenvalues 2245681, 86721 to the storing unit IP1, the eigenvalue 3347654 to the storing unit IP4, and the eigenvalue 123456 to the storing unit IP6.

After received the eigenvalues 2245681, 86721, the storing unit IP1 compares them with the internal eigenvalue table IP1′ (as shown in FIG. 5) and finds them in the table IP1′, so the file blocks Block2, Block4 corresponding to the two eigenvalues are returned to the processing unit B2. After received the eigenvalue 3347654, the storing unit IP4 compares it with the internal eigenvalue table IP4′ and finds it in the table IP4′, so the file block Block3 corresponding to the eigenvalue 3347654 is returned to the processing unit B2. After received the eigenvalues 123456, the storing unit IP6 compares it with the internal eigenvalue table IP6′ and finds it in the table IP6′, so the file block Block7 corresponding to the eigenvalue 123456 is returned to the processing unit B2.

After received the file blocks Block2, Block4, Block3, Block7 corresponding to eigenvalues 2245681, 86721, 3347654, 123456 returned from storing units IP1, IP4, IP6, the processing unit B2 stores the above data in the buffer area, and adds the above eigenvalues to the eigenvalue table W2. Simultaneously, the processing unit B2 sends back the above file blocks to the user end A1. After received the file blocks Block2, Block4, Block3, Block7 returned by the processing unit B2, the user end A1 recombines the file blocks Block0-Block7 into the complete file based on the sequence of the eigenvalue set in the eigenvalue table Y.

Partial data from the processing unit B2 and partial data from the far-end storing units IP1, IP4, IP6 by the download process will slightly increase the efficiency of Internet or Web utility. Since the file data completed the data cache preparation in the processing unit B2, the efficiency of the Internet or Web utility reaches to the top when a user reads the same file next time. Based on the security and protection of data, before sending eigenvalue set to the processing units, a user end needs to do chaotic processing for the sequence of an eigenvalue set, so that the processing unit is not able to obtain the sequence of the eigenvalue set to recombine the file even it obtains the entire eigenvalue set.

As cited, the cloud data storage system can also provide a virus elimination process. In the process, the storing units IP1-IP10 can take the responsibility of scanning the stored file blocks. If a virus data block is detected, the storing units IP1-IP10 inform the user end A1 the eigenvalues corresponding to the file data blocks containing the virus when the user end A1 queries. Or the storing units IP1-IP10 can actively inform all processing units B1-B3 to establish a virus eigenvalue table in order to inform the user end when the user end A1 queries. Thus, when a virus is detected, the cloud data storage system can proceed with treating the virus in real time to thereby prevent the virus from expanding, and thus substantially increase the speed of virus detection and elimination.

Although the present invention has been explained in relation to its preferred embodiment, it is to be understood that many other possible modifications and variations can be made without departing from the spirit and scope of the invention as hereinafter claimed.

What is claimed is:

1. A cloud data storage system, comprising:
a plurality of storing units;
a plurality of processing units connected to the plurality of storing units via the Internet or a local area network (LAN); and
a plurality of user ends connected to one of the processing units via the Internet or the LAN;
wherein an upload file to be stored by a user end is divided into a plurality of file blocks, a plurality of eigenvalues corresponding to the plurality of file blocks respectively are computed by an algorithm, and the eigenvalues are computed by another algorithm in order to decide which storing units the file blocks are stored in.

2. The system as claimed in claim 1, wherein the plurality of eigenvalues form an eigenvalue set corresponding to the upload file.

3. The system as claimed in claim 2, wherein the user end queries a corresponding storing unit to check whether there are same eigenvalues contained in the corresponding storing unit, and if the corresponding storing unit finds same eigenvalues, the file blocks corresponding to the same eigenvalues are not transferred, while the other file blocks not having the same eigenvalues are transferred to the storing unit.

4. The system as claimed in claim 2, wherein each processing unit comprises an eigenvalue table and a block data buffer area.

5. The system as claimed in claim 4, wherein the user end transfers the eigenvalue set to the one of the processing units in order to compare the eigenvalue set with the eigenvalue table of the processing unit for matching process.

6. The system as claimed in claim 5, wherein the user end does not transfer corresponding file blocks with same eigenvalues as those included in the eigenvalue table of the processing unit.

7. The system as claimed in claim 6, wherein the processing unit transfers corresponding eigenvalues not included in the eigenvalue table of the processing unit to a corresponding storing unit in order to proceed with matching process.

8. The system as claimed in claim 7, wherein the corresponding storing unit sends back the eigenvalues not included in the eigenvalue table of the storing unit to the processing unit, and the processing unit makes the user end to transfer file blocks corresponding to eigenvalues from the storing unit to the buffer area of the processing unit.

9. The system as claimed in claim 8, wherein the processing unit receives the file blocks and transfers them to the corresponding storing unit for data block storing.

10. The system as claimed in claim 2, wherein when one user end of the plurality of the user ends downloads the file, the user end downloads the corresponding file blocks based on the position of the storing unit corresponding to the plurality of the eigenvalue set.

11. The system as claimed in claim 10, wherein the user end combines the file blocks based on the sequence of the eigenvalue set of the file.

12. The system as claimed in claim 4, wherein, when one user end of the plurality of the user ends downloads the file, the user end transfers the eigenvalue set to one of the plurality of the processing units to proceed with data comparison according to the eigenvalue table of the processing unit.

13. The system as claimed in claim 12, wherein if the eigenvalue table of the processing unit contains the same eigenvalue, the processing unit extracts the corresponding file blocks from the buffer area and sends back to the user end.

14. The system as claimed in claim 12, wherein if the eigenvalue table of the processing unit does not contain the same eigenvalue, according to the eigenvalues, the processing unit obtains the position of the corresponding storing unit and sends the eigenvalues to the corresponding storing unit.

15. The system as claimed in claim 14, wherein the storing unit transfers the corresponding file blocks to the processing unit, and the processing unit receives the file blocks, stores them in the data buffer area of the file block and sends the file block back to the user end.

16. The system as claimed in claim 15, wherein the user end combines the file blocks according to the sequence of eigenvalues set of the file.

17. The system as claimed in claim 3, wherein the storing unit scans the stored file blocks and informs the user end the corresponding eigenvalues when the user end queries if the file blocks detected to contain virus or actively informs the processing units to establish a virus eigenvalue table in order to inform the user end when the user end queries.
